(19) United States
(12) Patent Application Publication
(10) Pub. No.: US 2013/0225467 A1
(43) Pub. Date: Aug. 29, 2013

(54) COMPOSITION AND METHOD TO PREVENT ANIONIC POLYMER PRECIPITATION

(71) Applicants: Shui-Ping Zhu, Gurnee, IL (US); Stephen W. Carson, Coatesville, PA (US)

(72) Inventors: Shui-Ping Zhu, Gurnee, IL (US); Stephen W. Carson, Coatesville, PA (US)

(21) Appl. No.: 13/819,439

(22) PCT Filed: Sep. 13, 2011
(86) PCT No.: PCT/US11/51305

§ 371 Date: May 20, 2013

Related U.S. Application Data
(60) Provisional application No. 61/383,453, filed on Sep. 16, 2010.

(51) Int. Cl. C11D 3/04; C11D 3/20; C11D 3/395; C11D 3/37

(52) U.S. Cl. CPC C11D 3/046; C11D 3/3746; C11D 3/2086; C11D 3/3956
USPC 510/229

(57) ABSTRACT

The present invention relates to an automatic dishwashing composition including from about 0.1 to 5 weight, percent cross-linked anionic polyacrylate polymer, from about 0.1 to 40 weight percent alkali metal citrate chelating agent and from about 1 to 40 weight percent alkali metal sulfate, with from about 0.1 to 20 weight percent nonionic surfactant and from about 0.05 to 8.0 weight percent bleaching agent as optional components. The present invention also relates to a method for reducing residues on washed and dried dish surfaces, which includes the use of an automatic dishwashing composition containing the above components,

### FIELD OF THE INVENTION

The present invention relates to a composition to be used as a detergent, and which may also be applicable to other applications, such as a hard surface cleaner or a carpet cleaner.

### BACKGROUND OF THE INVENTION

Automatic dishwashing detergents are well-known in the art. Most of the automatic dishwashing detergents currently available are suitable tier their intended purposes, i.e., effectively cleaning, and leaving previously soiled eating and cooking utensils in a generally spot-free, clean condition. Due to the special design of automatic dishwashers, the detergent should have very high viscosity for users to control proper dosage. Almost all of the liquid automatic dishwashing detergents exist in the form of a gel, which is, in most cases, made of a polymer thickener.

Polymer thickeners can be in three forms when dissolved in water: nonionic, which bears no charges; anionic, which bears multiple negative charges; and cationic, which bears multiple positive charges. Because tap water naturally contains positive charges of calcium (Ca⁺²) and magnesium (Mg⁺²) from the hardness of water, these positive ions can bind to the negative ions of anionic polymer and form precipitation deposits. This is one of the reasons that residues are formed, left on washed and dried dish surfaces in the form of so-called “water spots” and “filming” when a polyanionic polymer, such as Carbopol® 676, is used as the thickener.

In order to reduce the residues, it has been believed that a chelating agent should be used. The chelating agents used in automatic dishwashing gels thus far are of two types: inorganic and organic. The inorganic type includes, but is not limited to, phosphates, polyphosphates, carbonates, borates, silicates etc., while the organic type includes, but is not limited to, EDTA (ethylenediaminetetraacetic acid and its salts), NTA (nitrilotriacetic acid and its salts), phosphonates, etc.

The typical inorganic chelating agents of polyphosphates, phosphates, carbonates, silicates, etc. have the ability to chelate the Ca⁺² and Mg⁺² by forming water insoluble complexes as shown below:

CaCl₂ (10 percent, clear solution)+Na₅P₃O₁₀ (5 percent clear solution)=→Ca_{2.5} P₃O₁₀ (turbid solution)

CaCl₂ (10 percent, clear solution)+Na₂CO₃ (10 percent clear solution)=→CaCO₃ (turbid solution)

CaCl₂ (10 percent, clear solution)+Na₂SiO₃) percent clear solution)=→Ca SiO₃ (turbid solution),

hence reducing the residues from a polymer, and so have been used widely in auto dishwashing gel. formulations as mentioned in the prior art.

For instance, U.S. Pat. No. 5,981,457 describes a cross-linked polyacrylate as the thickener and tripolyphosphate as the builder/chelating agent. WO9429428 discloses polymers including cross-linked polyacrylate as the thickener, and carbonate, citrate, EDTA or NTA as the chelating agent (sometimes called a builder or water softener). U.S. Pat. No. 6,911,422 describes the manufacture of a transparent or translucent automatic dishwashing gel, but still contains 10 to 40 percent sodium tripolyphosphate as a chelating agent.

U.S. Pat. No. 7,459,420 does not mention the application of typical chelating agents, but rather sodium citrate as the water softener. In the formulation described in the reference, the polymer is not anionic, but rather nonionic; the xanthan gum thickener does not have a anionic functional group to bind the Ca⁺²/Mg⁺². In other words, the xanthan gum does not precipitate from tap water.

Different types of electrolytes have different efficacies to prevent or slow down polymer precipitation. It would be desirable if Ca⁺² anionic polymer salt precipitation could be avoided, reduced or slowed down for an automatic dishwashing process. Note that the wash waste is rinsed away with fresh water immediately after the wash cycle; the Ca⁺² complex with traditional chelating agents of carbonate, silicate, phosphate, or even tripolyphosphate is not water-soluble. These inorganic water-insoluble complexes can be rinsed away during the state of suspension before precipitation.

### SUMMARY OF THE INVENTION

The present invention provides an improved composition to prevent anionic polymers from precipitating (depending on type and amount of electrolytes), hence reducing the residues in the form of “water spots” or “films” on washed and dried dish surfaces, when a formulation containing the polymer is diluted with tap water during use conditions, especially at about 120° F. for an automatic dishwashing process. In accordance with the present invention, an electrolyte can prevent or slow down the precipitation of polymeric anionic polymers without the addition of any traditional inorganic or organic chelating agents. The composition of the present invention comprises from about 0.1 to 5 weight percent cross-linked anionic polacrylate polymer, from about 0.1 to 40 weight percent alkali metal citrate chelating agent and from about 1 to 40 weight percent alkali metal sulfate, with from about 0.1 to 20 weight percent nonionic surfactant and from about 0.05 to 8.0 weight percent bleaching agent as optional components.

The present invention further relates to a method for reducing residues on washed and dried dish surfaces which comprises the use of an automatic dishwashing composition comprising from about 0.1 to 5 weight percent cross-linked anionic polyacrylate polymer, from about 0.1 to 40 weight percent alkali metal citrate chelating agent, and from about 1 to 40 weight percent alkali metal sulfate, with from about 0.1 to 20 weight percent nonionic surfactant and from about 0.05 to 8.0 weight percent bleaching agent as optional components.

### DETAILED DESCRIPTION OF THE INVENTION

Particular terms to be used in describing the invention are as follows: An electrolyte is a water soluble salt, either inorganic or organic. When dissolved into water, an electrolyte can dissociate the molecule into positively and negatively charged ions. The negatively charged ion may or may not combine some mono-, di-valent (or higher than di-) metal or earth metal ions to form precipitation from water.

A chelating or sequestering agent is an organic, water soluble salt or acid. When it dissolves into water, a chelating agent can dissociate the molecule into positively and negatively charged ions. The negatively charged ions may combine divalent (or higher than di-) metal or earth metal ions to form a water soluble complex. Some chelating agents are also electrolytes, such as sodium citrate, potassium nitrilotriacetate (NTA), sodium ethylenediaminetetraacetate (EDTA).

A water softener is an inorganic water soluble salt, which can remove water hardness of calcium and magnesium ions from water by forming precipitation. Exemplary water softeners are, e.g., phosphate, polyphosphate, carbonate, bicarbonate and silicate. A water softener may also be (chemically) an electrolyte.

By “low foaming surfactants” it is meant surfactants that do not generate as much foam as regular surfactants, such as sodium dodecyl benzene sulfonate, fatty alcohol ethoxylate, fatty alcohol ethoxylate sulfate. Low foaming surfactants include but are not limited the following structures:

R(OCH₂CH₂)ₓ(OCH₂CH₂CH₂)_{y}OH

R(OCH₂CH₂)ₓ[OCH(CH₃)CH₂]_{y}OH

An antifoaming agent is an additive which reduces the surface tension of a solution or emulsion, thus inhibiting or modifying the formation of a foam. Commonly used antifoaming agents are insoluble oils, dimethyl polysiloxanes and other silicones, certain alcohols, stearates, fatty acid calcium salt and glycols. The additive is used to prevent formation of foam or is added to break a foam already formed,

A polycarboxylic polymer includes but is not limited to the following structure, including cross-linked and non-cross-linked versions:

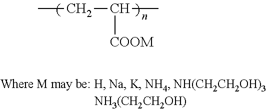

In accordance with the present invention, when an electrolyte where, for example Na₂SO₄, is added into a formulation with an anionic polymer, for example M polyacrylate (where M may be Na, K, NH₄ etc), and

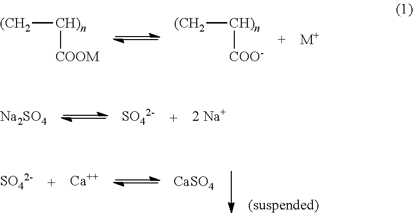

the formulation is diluted into tap water at 120° F for an automatic dish washing process, there are equilibriums established between different complexes, as shown by equation (1), (2), (3), (4) and (5).

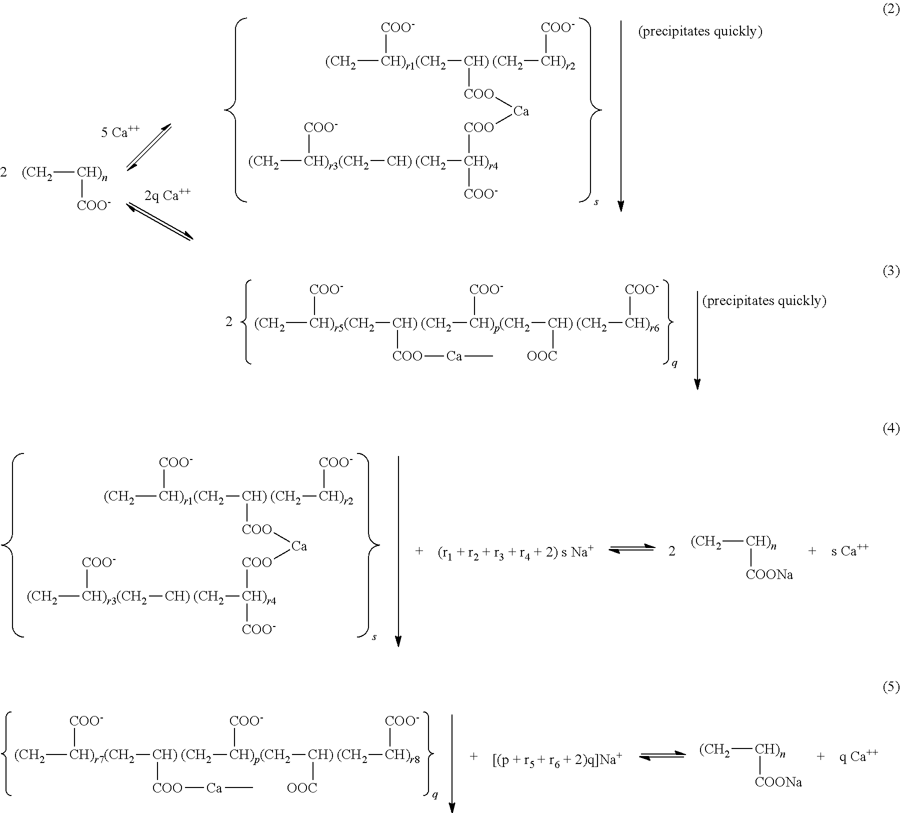

Note: In equations (2), (3), (4) & relationships between r, s, p, q and n are as follows:

0≦r_{1,2,3,4,5,6}≦n; 1≦s≦n; (r₁+r₂+1)s=(r₃+r₄+1)s=n

0≦p≦(n−r₅−r₆−2); 1≦q≦n; (p+r₅+r₆−2)q=n

Equation (1) indicates that the anionic portion from an electrolyte will combine with the Ca⁺², i.e., there will be less Ca⁺² left for the anionic polymer to combine with and then precipitate.

Equation (2) shows that two polymer molecules combine with s Ca⁺² ion to form precipitation.

Equation (3) indicates that one polymer molecule combines with q Ca⁺² ions to form precipitation.

Equations (4) and (5) demonstrate that Ca⁺² in water insoluble or precipitated complexes with the anionic polymer molecule can be replaced fully or partially by Na⁺ brought in by the electrolyte, and hence the precipitation will disappear or be reduced.

The present invention will now be described in the following non-limiting examples, as summarized in Table 1, below.

TABLE 1
Polyanionic Polymer Precipitation When Formulations Diluted in 120° F. Tap Water

| Ingredient | Example 1 | Example 2 | Example 3 | Example 4 |
|---|---|---|---|---|
| Plurafac ® SLF 180 (Low foaming nonionic | 20 | 20 | 20 | |
| surfactant) | | | | |
| Carbopol ® 676/Cross-linked anionic | 1.5 | 1.5 | 1.5 | 2 |
| polyacrylate polymer | | | | |
| Sodium citrate (chelating agent) | 2 | 2 | 2 | |
| H₂O₂ (a bleaching agent) | 4.5 | 4.5 | 5.5 | |
| STPP (chelating agent) | | | | |
| Sodium sulfate | | | 30 | |
| Deionized water | 72 | 72 | 41 | 98 |
| Total for the formulation | 100 percent | 100 percent | 100 percent | 100 percent |
| Appearance | gel | gel | gel | gel |
| Surface tension of 0.5 percent formulation at | 28.5 | 28.5 | 29.0 | |
| 70° F.: mN/m | | | | |
| Polymer precipitation of 0.5 percent sample | precipitation | precipitation | clear | precipitation |
| in 120° F. tap water | | | | |
| 0.44 grams Na₂SO₄ added in 200 ml of | precipitation | | | precipitation |
| above solution at 120° F. | disappears | | | disappears |
| 0.44 grams NaCl added in 200 ml of above | | precipitation | | |
| solution at 120° F. | | disappears | | |
| Ingredient | Example 5 | Example 6 | Example 7 | Example 8 |
| Plurafac ® SLF 180 (Low foaming nonionic | | | | |
| surfactant) | | | | |
| Carbopol ® 676/Cross-linked anionic | 2 | 2 | 2 | 2 |
| polyacrylate polymer | | | | |
| Sodium citrate (chelating agent) | | | | |
| H₂O₂ (a bleaching agent) | | | | |
| STPP (chelating agent) | | 17 | | |
| Sodium sulfate | | | 8 | 30 |
| Deionized water | 98 | 81 | 90 | 68 |
| Total for the formulation | 100 percent | 100 percent | 100 percent | 100 percent |
| Appearance | gel | gel | gel | emulsion |
| Surface tension of 0.5 percent formulation at | | | | 72.0 |
| 70° F.: mN/m | | | | |
| Polymer precipitation of 0.5 percent sample | precipitation | clear | precipitation | clear |
| in 120° F. tap water | | | | |
| 0.44 grams Na₂SO₄ added in 200 ml of | | | | |
| above solution at 120° F. | | | | |
| 0.44 grams NaCl added in 200 ml of above | precipitation | | | |
| solution at 120° F. | disappears | | | |

Example 1 contains 2 percent chelating agent of sodium citrate but when diluted to 0.5 percent in 120° F. tap water, the anionic polymer combines with the Ca⁺² to precipitate, which can be described by equation (2) & (3). When 0.44 grams of Na₂SO₄ is added to 200 ml of the 0.5 percent solution with precipitation, the polymer precipitation disappears, which is shown by equations (4) and (5).

Example 2 shows that when 0.44 grams of NaCl is added into 200 ml of 0.5 percent of solution with precipitation, the precipitation disappears, which is described by equations (4) and (5).

Example 3 demonstrates that when 30 percent Na₂SO₄ is directly added into the formulation which is then diluted into 0.5 percent in 120° F. tap water, there is no polymer precipitation observed. The phenomena can be described by equations (1) or (4) and (5).

Example 4 does not contain any surfactant or chelating agent, but merely the anionic polymer and deionized water, When it is diluted to 0.5 percent with 120° F. tap water the polymer precipitates confirms that it is the anionic polymer complex with Ca that precipitates, as concluded by Examples 1, 2 and 3. This is described by equations (2) and (3). The Ca-polymer complex precipitation in 0.5 percent diluted solution at 120° F. will disappear when 0.44 grains of Na₂SO₄ in added into 200 ml of the solution, as shown in equations (4) or (5).

Example 5 indicates that the electrolyte NaCl can have a similar function to prevent the polymer from precipitation in tap water as Na₂SO₄ does, although CaCl is water soluble and CaSO₄ is not.

Example 6 shows that STPP (sodium tripolyphosphate) behaves similarly as other electrolytes, such as NaCl and Na₂SO₄, to prevent the polymer from precipitating, although STPP is traditionally thought of as a key chelating agent, especially in automatic dishwashing gel detergents,

Examples 7 and 8 demonstrate that 8 percent Na₂SO₄ in the formulation is not sufficient to prevent the polymer from precipitation, but 30 percent is enough to do so. Examples 6, 7 and 8 suggest that different electrolytes have different thresholds to prevent the polymer from precipitating, which may depend on the types and amounts of electrolytes themselves, as well as other ingredients in the formulation.

In a preferred embodiment, the composition of the present invention comprises from about 0.2 to 3 weight percent cross-linked anionic polyacrylate polymer, from about 0.3 to 15 weight percent alkali metal citrate chelating agent and from about 2 to 30 weight percent alkali metal sulfate, with from about 0.2 to 10 weight percent nonionic surfactant and front about 0. 5 to 5 weight percent bleaching agent as optional components. In a particularly preferred embodiment, the composition of the present invention comprises from about 0.5 to 2 weight percent cross-linked anionic polyacrylate polymer, from about 0.5 to 5 weight percent alkali metal citrate chelating agent and from about 5 to 20 weight percent alkali metal sulfate, with front about I to 5 weight percent nonionic surfactant and from about 1 to 3 weight percent bleaching agent as optional components.

While the present invention has been described with respect to particular embodiments thereof, it is apparent that numerous other forms and modifications of the invention will be obvious to those skilled in the art. The appended claims and the present invention generally should be construed to cover all such obvious forms and modifications which are within the true spirit and scope of the presort invention.

What is claimed is:

1. An automatic dishwashing composition comprising from about 0.1 to 5 weight percent cross-linked anionic polyacrylate polymer, from about 0.1 to 40 weight percent alkali metal citrate chelating agent and from about 1 to 40 weight percent alkali metal sulfate, and optionally at least one of from about 0.1 to 20 weight percent nonionic surfactant and from about 0.05 to 8.0 weight percent bleaching agent.

2. The composition as recited in claim 1, wherein said cross-linked anionic polyacrylate polymer provides a high viscosity.

3. The composition as recited in claim 1, wherein said alkali metal citrate chelating agent is sodium citrate.

4. The composition as recited in claim 1, wherein said alkali metal sulfate is sodium sulfate.

5. The composition as recited in claim 1, wherein said nonionic surfactant is low-foaming.

6. The composition as recited in claim 1, wherein said bleaching agent is hydrogen peroxide.

7. The composition as recited in claim 2, comprising from about 0.1 to 5 weight percent cross-linked anionic polyacrylate polymer.

8. The composition as recited in claim 3, comprising from about 0.1 to 40 weight percent sodium citrate.

9. The composition as recited in claim 4, comprising from about 2 to 30 percent sodium sulfate.

10. The composition as recited in claim 1, comprising from about 0.2 to 10 weight percent nonionic surfactant.

11. The composition as recited in claim 6, comprising from about 0.5 to 5 percent hydrogen peroxide,

12. An automatic dishwashing composition comprising from about 0.5 to 2 weight percent cross-linked anionic polyacrylate polymer, from about 0.5 to 5 weight percent alkali metal citrate chelating agent and from about 5 to 20 weight percent alkali metal sulfate, and optionally at least one of from about 1 to 5 weight percent nonionic surfactant and from about 1 to 3 weight percent bleaching agent.

13. A method for reducing residues on washed and dried dish surfaces which comprises the use of an automatic dishwashing composition comprising from about 0.1 to 5 weight percent cross-linked anionic polyacrylate polymer, from about 0.1 to 40 weight percent alkali metal citrate chelating agent, and from about 1 to 40 weight percent alkali metal sulfate, and optionally at least one of from about 0.1 to 20 weight percent nonionic surfactant and from about 0.05 to 8.0 weight percent bleaching agent.

14. The method as recited in claim 13, wherein said cross-linked anionic polyacrylate polymer provides a high viscosity.

15. The method as recited in claim 13, wherein said alkali metal citrate chelating agent is sodium citrate.

16. The method as recited in claim 13, wherein said alkali metal sulfate is sodium sulfate.

17. The method as recited in claim 13, wherein said nonionic surfactant is low-foaming.

18. The method as recited in claim 13, wherein said bleaching agent is hydrogen peroxide.
